(19) United States
(12) Patent Application Publication
(10) Pub. No.: US 2008/0037473 A1
(43) Pub. Date: Feb. 14, 2008

(54) COMMUNICATION DEVICE CONTROLLED CALL HANDOFFS BETWEEN COMMUNICATION NETWORKS

(75) Inventors: David Brown, Abbotsley (GB); Michael J. Ward, Mebane, NC (US); Ajit B. Pendse, Durham, NC (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: TRINITY CONVERGENCE LIMITED, Cambridge (GB)

(21) Appl. No.: 11/837,314

(22) Filed: Aug. 10, 2007

Related U.S. Application Data
(60) Provisional application No. 60/822,337, filed on Aug. 14, 2006.

(51) Int. Cl. H04Q 7/22

(52) U.S. Cl. 370/332

(57) ABSTRACT

Methods, apparatuses, and articles of manufacture for determining, by a first communication device communicatively coupled with a second communication device by a first communication connection of a first communication network, whether to establish a second communication connection of a second communication network to the second communication device, are described herein. In some embodiments, the first and second communication networks may be different communication networks, and the determining may be based on a comparison of a first communication network signal strength to a threshold or on one or more user preferences of a user of the first communication device. Further, in various embodiments, the first communication device may establish the second communication connection to the second communication device, if it is determined that the second communication connection should be established, while the first communication device remains communicatively coupled with the second communication device via the first communication connection.

### RELATED APPLICATIONS

This non-provisional application claims priority to U.S. provisional patent application No. 60/822,337, filed on Aug. 14, 2006 and hereby incorporates the entire specification of the 60/822,337 provisional application by reference, to the extent the provisional specification is consistent with the present specification.

### FIELD

Embodiments of the present invention relate to the fields of communications, in particular, to methods and apparatuses for communication device controlled handing off calls between communication networks.

### BACKGROUND

Advances in integrated circuit, processor, telecommunication, networking and other related technologies have led to the proliferation of a wide variety of communication devices having a wide range of communication capabilities. Such communication devices may allow users of such devices to make calls through a variety of communication networks in accordance with various protocols and standards. For example, such communication devices may be able to communicate via wideband Voice Over IP (VOIP) telephony, cellular communication like GSM and 3G, and/or wireless communication like wireless fidelity otherwise known as WiFi (802.11x) and Worldwide Interoperability for Microwave Access otherwise known as WiMax (802.16x).

One of the imitations of communication networks such as cellular and wireless (e.g., WiFi and WiMax) networks is that it can be cumbersome if not impossible to hand off a call originally made through one type of communication network, such as a cellular network, to another type of communication network, such as a wireless network (e.g., WiFi or WiMax network). One prior art solution for handing off a call from one type of communication network to another type of communication network relies on the coordination of the handoff of the call by the service providers of the two communication networks (e.g., the cellular and wireless network providers). Unfortunately such solutions may require that complex operator agreements be in place before the handoff of the call between the two communication networks can be implemented.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates a flowchart view of exemplary operations in accordance with various embodiments of the invention; and

FIG. 3 illustrates a communication device in accordance with various embodiments of the present invention.

### DETAILED DESCRIPTION OF ILLUSTRATIVE EMBODIMENTS OF THE INVENTION

According to various embodiments of the present invention, a call made through a first communication network may be transferred or handed off to a second communication network seamlessly and vice versa without requiring intervention by communication network providers. Such a handover may be required, for example, when the caller moves out of the range of one wireless network and into the range of another wireless network. In some embodiments, the first communication network may be a non-cellular network such as s VoIP network (e.g., Skype network) and/or a wireless network (e.g., a WiFi or a WiMAX network) while the second communication network may be a cellular (e.g., GSM or CDMA) network. Embodiments of the present invention allows a user of a communication device to roam freely between an area where they have, for example, a wireless LAN coverage to an area where they have, for example, cellular coverage (and visa versa) without an active call being dropped and/or without requiring changes to network infrastructures. In fact, no cooperation of any sort between providers of the network infrastructures used by the calls is required, in some embodiments.

In various embodiments, handovers of calls may be executed without a need to have a central server to coordinate the handovers. For example, in certain types of networks including peer-to-peer (P2P) networks such as Skype networks, a central server may not be used to coordinate the transfer of calls. Instead, client-based handover may be performed.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

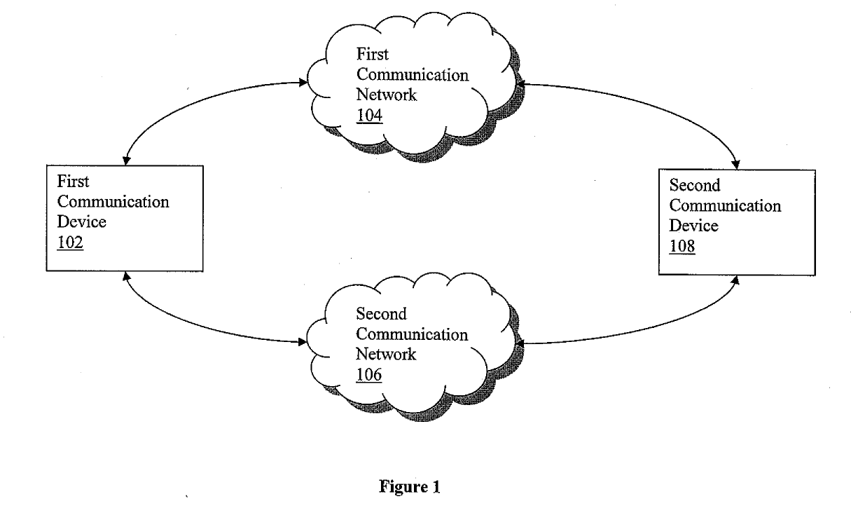

FIG. 1 illustrates an overview of the invention, in accordance with various embodiments. As illustrated, a first communication device 102 may be communicatively coupled to a second communication device 108 via communication connections of one or both of first and second communication networks 10 First communication network 104 and second communication network 106 may be different communication networks of different network types. For example, first communication network 104 may be one of a cellular, a wireless, or a wired communication network, and second communication network 106 may be another, different type. In various embodiments, first communication device 102 may establish a first communication connection with the second communication device 108 via the first communication network 104. First communication device 102 may then determine whether to establish a second communication connection, such as a replacement or alternative connection, to second communication device 108 via the second communication network 106. Hereinafter, a “communication connection” may simply be referred to as a “connection”. The determining may be based, in one embodiment, on a first communication network 104 signal strength or a preference of a user of first communication device 102. For example, a user may set a preference for all video calls to be handled by an IP network. In response to the user upgrading the connection from a cell phone call to a video call, first communication device 102 may determine that a second, IP connection should be established. If the first communication device 102 determines that the second connection should be established, the first communication device 102 may establish the second connection while still connected to the second communication device 108 by the first connection. Upon establishing the second connection, the first communication device 102 may drop the first connection.

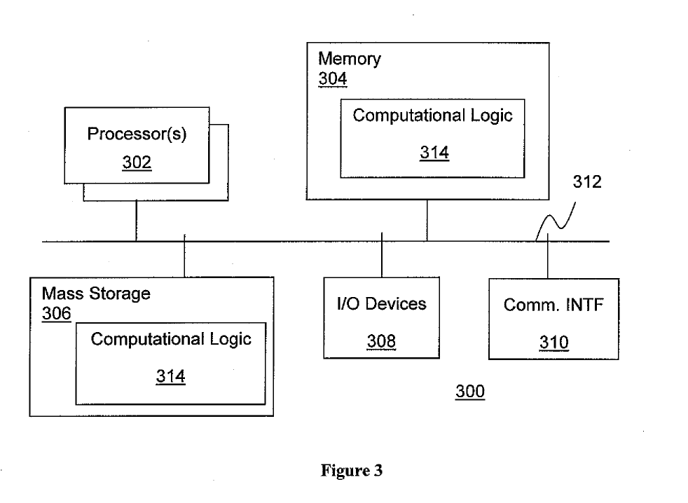

In various embodiments, first and second communication devices 102/108 may be any sort of electronic devices, such as wireless mobile phones, personal digital assistants (PDA), handsets, media players, laptop computers, personal computers (PC), set-top boxes, remote controls, game controllers, in-vehicle navigation consoles, medical equipment, or kiosks. As mentioned above, first and second communication devices 102/108 may have means of connecting to first and second communication networks 104/106 and of establishing connections across those communication networks. An exemplary communication device capable of operating as the first or second communication devices 102/108 is shown in greater detail in FIG. 3 and is discussed further below in reference to that figure.

As is shown, first communication network 104 and second communication network 106 may be different communication networks and may have different communication network types. First communication network 104 may be one of a cellular network, a wireless network, or a wired network, and second communication network 106 may be another, different one of these communication network types. In some embodiments, wired and/or wireless communication networks may facilitate a voice over IP (VOIP) network. In one embodiment, the first communication network 104 may be a VoIP network of a wireless network, and second communication network 106 may be a cellular network. In another embodiment, the first communication network 104 may be cellular network, and second communication network 106 may be a VoIP network of a wireless network. Communication networks 104/106 may be any cellular, wired, and/or wireless (including or not including VoIP networks) known in the art. In some embodiments, communication networks 104/106 may each have a service provider handling registration, providing network infrastructure, etc. Wireless networks may have a plurality of access points provide access to communication networks 104/106, and cellular networks may have a plurality of base stations provide access to communication networks 104/106.

In order to explain the operations of the first communication device 102 and the second communication device 108, exemplary embodiments are described in the following paragraphs. These exemplary embodiments are provided only for the sake of illustration and in no way limit the operations of the communication devices 102/108, the types of the communication devices 102/108, and the types of the communication networks 104/106.

### EXAMPLES

In a first exemplary embodiment, a first call may be made through a VoIP network such as a Skype network that is accessible through a wireless network 104, and the call may be transferred to a cellular network 106. The process may begin when a first user initiates a VoIP call through the VoIP network using a first communication device (CD) 102 to a second CD 108 of a second user. In the embodiment, such a call may be facilitated by using a directory having a profile of the second user, the directory included in the first CD 102. The profile may include an identifier associated with the second communication device 108, such as a phone number or IP address. The second user, in the embodiment, may also be a VoIP user. The first CD 102 may then monitor the quality of the signals from the access point (AP) of the wireless network 104.

The first CD 102 may then subsequently determine whether the quality of the signals from the AP of the wireless network 104 is less than a threshold and whether there is sufficiently strong cellular signals at the first CD 102 to support a call on the cellular network 106 (or the first user has configured her CD 102 to indicate that she has a preference to use the cellular network 106 when available). If so, then a determination may be made as to whether the first CD 102 can register with a provider of the cellular network 106 if it has not already been registered with the cellular network 106. If it cannot be registered, then the call continues on the wireless network 104. On the other hand, if registration is possible, then the first CD 102 may register with the provider of the cellular network 106 if it has not already been registered. The first CD 102 may then place a call to the second CD 108 of the second user using, for example, a cellular phone number, such as a Skype-In number, that, when called, forwards to a voice over IP call receiver. Such a number may be configured in, for example, the second CD 108's Skype profile entry stored in the above-mentioned directory. The second CD 108 may then be notified that there is an incoming cellular call. The first CD 102 may then call the second CD 108 via the cellular network 106. The caller identification of the incoming call may indicate that the call is from the first user of the first CD 102, and as a result, the call may be answered by the second CD 108, in some embodiments automatically. Once the second CD 108 has answered the call, the first CD 102 may drop the original VoIP call, and audio and transmission for the first CD 102 may be switched to the cellular call.

In a second exemplary embodiment, a first call may be made through a cellular network 104, and the call may be transferred to a VoIP network such as a Skype network that is accessible through a wireless network 106. The process may begin when a first user initiates a cellular call through the cellular network 104 using a first communication device (CD) 102 to a second CD 108 of a second user. As mentioned above, the call may be facilitated by a directory included in the first CD 102. The first CD 102 may then monitor the quality of the signals from the base station (BS) of the cellular network 104.

The first CD 102 may then subsequently determine whether the quality of the signals from the BS of the cellular network 104 is less than a threshold and whether there is sufficiently strong wireless signals at the first CD 102 to support a call on the wireless network 106 (or the first user has configured her CD 102 to indicate that she has a preference to use the wireless network 106 when available). If so, then a determination may be made as to whether the first CD 102 can register with a provider of the wireless network 106 (i.e., AP of the wireless network 106) if it has not already been registered with the wireless network 106. If it cannot be registered, then the call continues on the cellular network 104. On the other hand, if registration is possible, then the first CD 102 may register with the provider of the wireless network 106 if it has not already been registered. The first CD 102 may then place a call to the cellular number of the second CD 108 of the second user (as may be registered in the second user's profile entry in the directory) using, for example, a cellular phone number called using a VoIP to cellular service such as Skype Out. The second CD 108 may then be notified that there is an incoming call. The first CD 102 may then call the second CD 108 via the wireless network 106. The caller identification of the incoming call may indicate that the call is from the first user of the first CD 102, and as a result, the call may be answered by the second CD 108. Once the second CD 108 has answered the call, the first CD 102 may drop the original cellular call, and audio and transmission for the first CD 102 may be switched to the wireless call (i.e., VoIP call).

Although the above embodiments allow for the transfer of calls between two wireless networks 104/106 (e.g., between a cellular and non-cellular wireless networks), in alternative embodiments, calls may also be transferred between a wired and a wireless network 104/106. For example, suppose a user enters his work office and then docks his CD 102 (e.g., telephone device) to a dock. After docking, the user may decide to call someone and may be allowed to talk over, for example, Skype via Ethernet 104 using a handsfree communication device 102. During the call, the user may suddenly decide to leave his office but wishes to continue with his call. However, the user may not have access to wireless LAN in his office. Instead, the user may simply push a button on his dock to indicate that the user wishes to undock. The CD 102 may then establish a connection over a cellular network 106, and once established, the dock may indicate to the user that the user can remove the CD 102 from the dock and continue his call using the CD 102 outside his office.

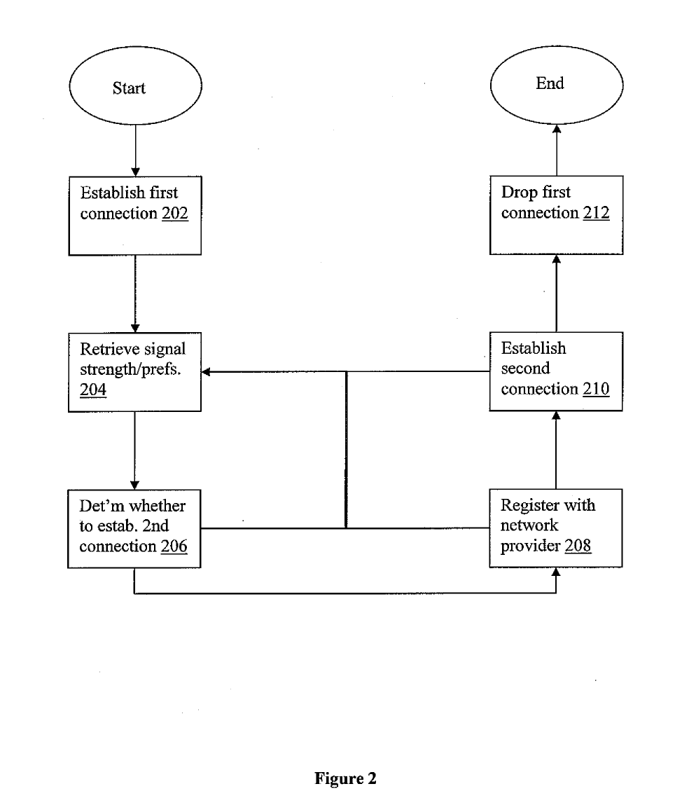

FIG. 2 illustrates a flowchart view of exemplary operations in accordance with various embodiments of the invention. In various embodiments, a first communication device may establish a first connection of a first communication network to a second communication device, block 202. In one embodiment, the establishing may comprise calling second communication device, and the call may be a voice over IP call or a cellular call. Upon establishing the first connection, the first communication device may retrieve a first communication network signal strength from an access point of the first connection, and/or may retrieve one or more user preferences of a user of the first communication device, block 204. In various embodiments, the first communication device may repeat the retrieval periodically.

In some embodiments, the first communication device may then determine whether to establish a second connection of a second communication network to the second communication device, the first and second communication networks being different communication networks, block 206. In various embodiments, the determining may be performed after each retrieval, at a predetermined periodic evaluation point in time, or in response to the occurrence of a network or device event. In one embodiment, the determining may be based on a comparison of a first communication network signal strength to a threshold or on one or more user preferences of a user of the first communication device. The first communication network may be one of a wireless and a cellular network, and the second communication network may be the other of the wireless and the cellular network. If it is determined that the second connection should not be established, the first and second communication devices may continue to communicate via the first connection, and the first communication device may repeat retrieving, block 204, and determining, block 206.

If it is determined that the second connection should be established, the first communication device may determine whether registering with a provider of the second communication network is needed and, if needed, may register with a provider of the second communication network prior to establishing the second connection, block 208.

In various embodiments, the first communication device may then establish the second connection to the second communication device while the first communication device remains communicatively coupled with the second communication device via the first connection, block 210. In some embodiments, establishing the second connection may comprise calling the second communication device, the call being a voice over IP call or a cellular call, and the second connection may be different from the first connection. In one embodiment, the second communication device may be associated with a profile, and calling the second communication device to establish the second connection may comprise calling an identifier stored in association with the profile. The identifier may be a cellular phone number that, when called, forwards to a voice over IP call receiver, or may be associated with a voice over IP call receiver and forwards to a cellular phone number.

In some embodiments, after establishing the second connection, the first communication device may drop the first connection, block 212. In some embodiments, the first communication device may then determine whether to establish a third connection of a third communication network to the second communication device, the second determining being based on a second comparison of a second communication network signal strength to a second threshold or on the one or more user preferences of the first user of the first communication device. Likewise, the determining may be performed after each retrieval of signal strength data associated with the second and/or third communication network, at a predetermined periodic evaluation point in time, or in response to the occurrence of a network/device event.

FIG. 3 illustrates a communication device suitable for practicing the present invention, in accordance with various embodiments of the present invention. As shown, communication device 300 may include one or more processors 302, and system memory 304. Additionally, communication device 300 may include mass storage devices 306 (such as diskette, hard drive, CDROM and so forth), input/output devices 308 (such as keyboard, cursor control and so forth) and communication interfaces 310 (such as network interface cards, modems and so forth) enabling wireless and cellular communications. The elements may be coupled to each other via system bus 312, which represents one or more buses. In the case of multiple buses, they may be bridged by one or more bus bridges (not shown).

System memory 304 and mass storage 306 may be employed to store a working copy and a permanent copy of the programming instructions implementing one or more aspects of the above described teachings to practice the present invention, such as computational logic 314. The programming instructions may be implemented in assembler instructions supported by processor(s) 302 or high level languages, such as C, that may be compiled into such instructions.

The permanent copy of the programming instructions may be placed into permanent storage 306 in the factory, or in the field, through e.g. a distribution medium (not shown) or through communication interface 310 (from a distribution server (not shown)).

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
determining, by a first communication device communicatively coupled with a second communication device by a first communication connection of a first communication network, whether to establish a second communication connection of a second communication network to the second communication device, the first and second communication networks being different communication networks and the determining being based on a comparison of a first communication network signal strength to a threshold or on one or more user preferences of a user of the first communication device; and
if it is determined that the second communication connection should be established, establishing, by the first communication device, the second communication connection to the second communication device while the first communication device remains communicatively coupled with the second communication device via the first communication connection.

2. The method of claim 1, further comprising second establishing, by the first communication device, the first communication connection.

3. The method of claim 2, wherein establishing the first communication connection comprises calling second communication device, and the call is a voice over IP call or a cellular call.

4. The method of claim 1, wherein the first communication network is one of a wireless and a cellular network, and the second communication network is the other of the wireless and the cellular network.

5. The method of claim 1, wherein establishing the second communication connection comprises calling the second communication device, the call being a voice over IP call or a cellular call, and the second communication connection is different from the first communication connection.

6. The method of claim 5, wherein the second communication device is associated with a profile, and calling the second communication device to establish the second communication connection comprises calling an identifier stored in association with the profile.

7. The method of claim 6, wherein the identifier is a cellular phone number that, when called, forwards to a voice over IP call receiver, or is associated with a voice over IP call receiver and forwards to a cellular phone number.

8. The method of claim 1, further comprising, after said establishing, dropping the first communication connection.

9. The method of claim 8, further comprising second determining whether to establish a third communication connection of the first communication network to the second communication device, the second determining being based on a second comparison of a second communication network signal strength to a second threshold or on the one or more user preferences of the first user of the first communication device.

10. The method of claim 1, further comprising retrieving the network signal strength from an access point of the first communication connection.

11. The method of claim 1, further comprising registering with a provider of the second communication network prior to said establishing.

12. A first communication device comprising:
a processor;
a communication interface coupled to the processor to communicatively couple the first communication device with a second communication device by a first communication connection of a first communication network; and
logic operated by the processor and adapted to
determine, while communicatively coupled by the first communication connection, whether to establish a second communication connection of a second communication network to the second communication device, the first and second communication networks being different communication networks and the determining being based on a comparison of a first communication network signal strength to a threshold or on one or more user preferences of a user of the first communication device, and
if it is determined that the second communication connection should be established, establish the second communication connection to the second communication device while the first communication device remains communicatively coupled with the second communication device via the first communication connection.

13. The first communication device of claim 12, wherein the logic is further adapted to establish the first communication connection.

14. The first communication device of claim 12, wherein the first communication network is one of a wireless and a cellular network, and the second communication network is the other of the wireless and the cellular network.

15. The first communication device of claim 12, wherein the logic is adapted to said establish the second communication connection, and said establishing comprises calling the second communication device, the call being a voice over IP call or a cellular call, and the second communication connection is different from the first communication connection.

16. The first communication device of claim 12, wherein the logic is further adapted to, after said establish, drop the first communication connection.

17. The first communication device of claim 12, wherein the logic is further adapted to register with a provider of the second communication network prior to said establish.

18. A method comprising:
determining, by a first communication device communicatively coupled with a second communication device by a voice over IP connection of a wireless network, whether to establish a cellular connection of a cellular network to the second communication device, the determining being based on a comparison of a wireless network signal strength to a threshold or on one or more user preferences of a user of the first communication device; and
if it is determined that the cellular connection should be established, calling, by the first communication device, the second communication device to establish the cellular connection to the second communication device while the first communication device remains communicatively coupled with the second communication device via the voice over IP connection.

19. The method of claim 18, further comprising second calling, by the first communication device, the second communication device to establish the voice over IP connection to the second communication device, and the call is a voice over IP call.

20. The method of claim 18, further comprising, after said establishing, dropping the voice over IP connection.
